(19) United States
(12) Patent Application Publication
(10) Pub. No.: US 2002/0029697 A1
(43) Pub. Date: Mar. 14, 2002

(54) Frozen dessert holder

(76) Inventor: Perry Oshio, Gardena, CA (US)

Correspondence Address: Matthew J. Peirce, Esq., 1550 Starlight Canyon Avenue, Las Vegas, NV, 89123, US

(21) Appl. No.: 09/949,400

(22) Filed: Sep. 7, 2001

Related U.S. Application Data
(60) Provisional application No. 60/231,238, filed on Sep. 8, 2000.

(51) Int. Cl. A23L 1/00; A47J 9/00

(52) U.S. Cl. 99/426; 99/353; 99/450.1

(57) ABSTRACT

A new and improved apparatus is disclosed which would catch drippings from an ice cream bar or ice cream treat while a user would be eating the ice cream bar or ice cream treat. The apparatus would comprise a handle and an upper cup portion, with the upper cup portion being removably mounted on top of the handle portion. The upper cup portion has a hole in the middle, which would allow the upper cup portion to be removably mounted on top of the handle portion. The handle portion would have two ends, a top end and a bottom end, with the top end having a hole. The handle portion also has an internal slot, with the top-mounted hole being an entrance to the internal slot.

### BACKGROUND OF THE INVENTION

The present invention is that of a new and improved apparatus which would catch drippings from an ice cream bar or ice cream treat while a user would be eating the ice cream bar or ice cream treat.

### DESCRIPTION OF THE PRIOR ART

U.S. Pat. No. 5,224,646, issued to Biancosino, discloses an ice cream holder for collecting liquid from ice cream as it melts and includes a peripheral ring with a plurality of apertures and a drinking slot.

U.S. Pat. No. D291,620, issued to Porchia, discloses a design for an ice cream cone holder.

U.S. Pat. No. 4,226,355, issued to Helfrich, Jr., discloses an ice cream holder for insertion in an ice cream cone comprising a thin-wall member of generally funnel shape and open at each of its ends.

### SUMMARY OF THE INVENTION

The present invention is that of a new and improved apparatus which would catch drippings from an ice cream bar or treat or other frozen dessert treat while a user would be eating the frozen delicacy. The apparatus would comprise a handle and an upper cup portion, with the upper cup portion being removably mounted on top of the handle portion. The upper cup portion has a hole in the middle, which would allow the upper cup portion to be removably mounted on top of the handle portion. The handle portion would have two ends, a top end and a bottom end, with the top end having a hole. The handle portion also has an internal slot, with the top-mounted hole being an entrance to the internal slot.

There has thus been outlined, rather broadly, the more important features of an apparatus for helping an individual while eating ice cream or another frozen dessert in order that the detailed description thereof that follows may be better understood and in order that the present contribution to the art may be better appreciated. There are, of course, additional features of the apparatus for helping an individual while eating ice cream or another frozen dessert that will be described hereinafter and which will form the subject matter of the claims appended hereto.

In this respect, before explaining at least one embodiment of the apparatus for helping an individual while eating ice cream or another frozen dessert in detail, it is to be understood that the apparatus for helping an individual while eating ice cream or another frozen dessert is not limited in its application to the details of construction and to the arrangements of the components set forth in the following description or illustrated in the drawings. The apparatus for helping an individual while eating ice cream or another frozen dessert is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present apparatus for helping an individual while eating ice cream or another frozen dessert. It is important, therefore, that the claims be regarded as including such equivalent constructions insofar as they do not depart from the spirit and scope of the present invention.

It is therefore an object of the present invention to provide an apparatus for helping an individual while eating ice cream or another frozen dessert which has all of the advantages of the prior art and none of the disadvantages.

It is another object of the present invention to provide an apparatus for helping an individual while eating ice cream or another frozen dessert which may be easily and efficiently manufactured and marketed.

It is another object of the present invention to provide an apparatus for helping an individual while eating ice cream which is of durable and reliable construction.

It is yet another object of the present invention to provide an apparatus for helping an individual while eating ice cream or another frozen dessert which is economically affordable and available for relevant purchasing government entities.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a perspective view of the upper cup portion of the present invention.

FIG. 2 shows a perspective view of the handle portion of the present invention.

FIG. 3 shows the present invention as it would appear in use.

FIG. 4 shows the present invention in use.

### DESCRIPTION OF THE PREFERRED EMBODIMENT

FIG. 1 shows a perspective view of the upper cup portion 2 of the present invention. Upper cup portion 2 would preferably be bowl-shaped and cylindrical in nature. Upper cup portion 2 would be removably mounted on top of the handle portion 4. Upper cup portion 2 has a hole 6 in the middle of upper cup portion 2, which would allow the upper cup portion 2 to be removably mounted on top of the handle portion 4. Upper cup portion 2 would preferably have a diameter of approximately four inches, with the hole 6 preferably having a diameter of approximately one and one-half inches.

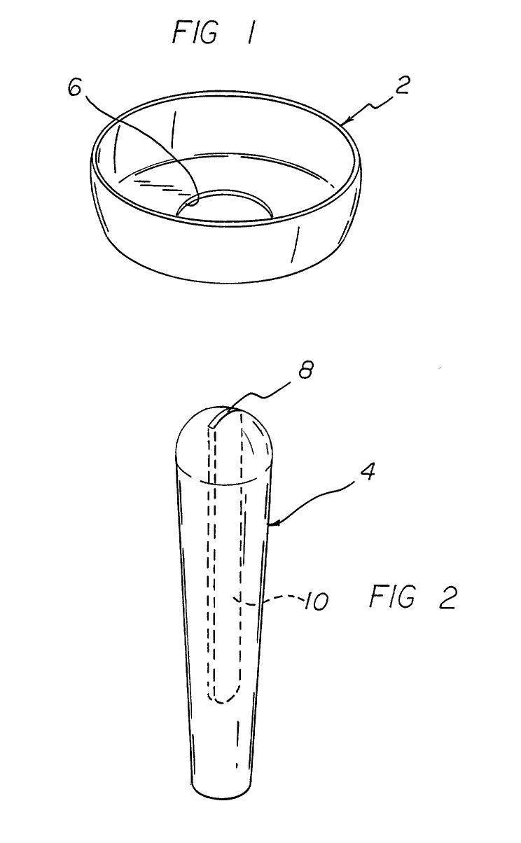

FIG. 2 shows a perspective view of the handle portion 4 of the present invention. The handle portion 4 would have two ends, a top end and a bottom end, with the top end having a hole 8. The handle portion 4 also has an internal slot 10, with the top-mounted hole 8 serving as an entrance to the internal slot 10. In use, a user would place the stick portion 12 of an ice cream bar or ice cream treat into internal slot 10, with the ice cream portion of the ice cream bar or ice cream treat resting on the top of upper cup portion 2.

Handle portion 4 would have a diameter that would taper off slightly from the top end to the bottom end of handle portion 4, with the top end of handle portion 4 having a diameter of approximately one and one-half inches and the bottom end of handle portion 4 having a diameter of approximately three-fourths of an inch. The top-mounted hole 8 in the top end of handle portion 4 would have a preferable diameter of approximately three-fourths of an inch.

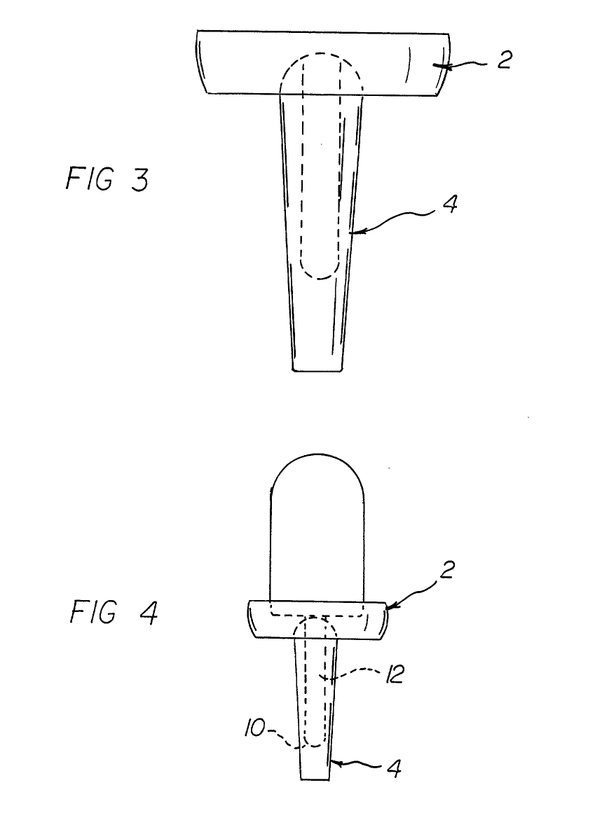

FIG. 3 shows the present invention as it would appear in use. As can be seen, upper cup portion 2 would be removably mounted on top of the handle portion 4. Further, handle 4 is tapered to ensure that when upper cup portion 2 is placed on top of and over handle 4, upper cup portion 2 would move down until a certain point and would then removably rest on handle 4.

FIG. 4 shows the present invention in use. In this drawing, a user has placed the stick portion 12 of an ice cream bar or ice cream treat into internal slot 10, with the ice cream portion of the ice cream bar or ice cream treat ending up resting on the top of upper cup portion 2. As the ice cream on the ice cream bar or ice cream treat would melt, the ice cream would drip into upper cup portion 2 and not over a user's hands or clothes.

What I claim as my invention is:

1. An apparatus for use while eating frozen dessert treats comprising:
(a) an upper cup portion, the upper cup portion preferably being bowl-shaped, the upper cup portion having a centrally-located hole,
(b) a handle having two ends, a first end and a second end, the handle being cylindrical in nature, the first end of the handle having a hole, the diameter of the handle tapering off slightly from the first end of the handle to the second end of the handle,
(c) an internal slot located within the handle, the internal slot having two ends, a first end and a second end, the first end of the internal slot culminating in the hole located on the first end of the handle,
(d) wherein the first end of the handle would be inserted through the centrally-located hole on the upper cup portion until the diameter of the handle would equal the diameter of the centrally-located hole.

2. An apparatus for use while eating frozen dessert treats according to claim 1 wherein the upper cup portion has a diameter of approximately four inches, further wherein the centrally-located hole having an approximate diameter of one and one-half inches, further wherein the diameter of the handle at the first end of the handle is approximately one and one-half inches, further wherein the diameter of the handle at the second end of the handle is approximately three-fourths of an inch, further wherein the diameter of the internal slot is approximately three-fourths of an inch.

3. An apparatus for use while eating frozen dessert treats according to claim 2 wherein the first end of the handle is rounded and further wherein the second end of the handle is flat.

4. An apparatus for use while eating frozen dessert treats according to claim 2 in combination with
(a) a frozen dessert,
(b) a holding stick having two ends, a first end and a second end, the first end of the holding stick attached to the frozen dessert,
(c) wherein the second end of the holding stick would be inserted into the internal slot within the handle.
